(19) United States
(12) Patent Application Publication
(10) Pub. No.: US 2011/0100488 A1
(43) Pub. Date: May 5, 2011

(54) STEAM TRAP ASSEMBLY AND METHOD OF OPERATION

(75) Inventor: Dowlatram Somrah, New Hyde Park, NY (US)

(73) Assignee: CONSOLIDATED EDISON COMPANY OF NEW YORK, INC., New York, NY (US)

(21) Appl. No.: 12/608,330

(22) Filed: Oct. 29, 2009

(51) Int. Cl. E03B 7/07; G01M 3/08

(52) U.S. Cl. 137/544; 73/49.1

(57) ABSTRACT

A steam trap arrangement is provided. The steam trap includes an inlet header having an inner bore. A strainer having a plurality of perforations is positioned within the inner bore. A plurality of discharge ports couple the inlet header to a conduit, where each conduit includes a steam trap. The conduits are arranged to be offset from the discharge ports. The conduits fluidly couple the inlet header to an outlet header. The outlet header includes a discharge port for draining condensate from the system.

### BACKGROUND OF THE INVENTION

The subject matter disclosed herein relates to a steam trap, and in particular relates to a steam trap having improved resistance to blockage, increased capacity and a method for detecting blockages.

Steam traps are used in a wide variety of applications where steam is used as a medium for transferring thermal energy. Such applications include district heating or teleheating systems where a central heating plant boils water to create stream. The steam is transported via insulated pipes to subscribing facilities and buildings, which purchase the steam from a steam utility. Similar to an electric meter, a steam meter measures the amount of steam used by a particular building and the building owner is charged on a periodic basis.

The transfer of the steam from the central heating plant often results in the routing of steam pipes under streets and other areas. The steam conduits are insulated, and often enclosed within conduits to protect the insulation and steam pipes from the surrounding environment. During the normal course of transfer, some portion of the steam will condense back into liquid form. The condensed water is typically drained to the lowest point in the system where a device, such as a steam trap is installed. The steam trap is arranged to open when condensate is present and close in the presence of steam. The condensate is removed from the system to prevent a phenomena known as “water hammering” from occurring. Water hammering occurs if sub-cooled condensate backs up into steam section of the system.

There are two types of water hammering: 1) slug type; and, 2) steam bubble collapse. In slug type water hammering, the high velocity steam propels a “slug” of condensate into a fitting such as an elbow that causes a change in the direction of the flow. The impact of the slug against the fitting creates a loud hammering noise and induces high stresses in the fitting and piping system. In the steam bubble collapse type of water hammering cold or significantly subcooled condensate in a horizontal pipe or inclined pipe is put in motion by the differential pressure across the condensate. Due to the pitch of the pipe, steam flows over the sub-cooled condensate. The condensate rapidly condenses the steam and affects its velocity. The high velocity of the steam over the sub-cooled condensate creates waves in the surface of the condensate. A high enough wave will trap a steam bubble in the condensate. The suppressing of the steam bubble by the cold condensate causes a condensation-induced water hammer. The bubble collapse cause sharp pressure waves or water hammer. It should be appreciated that when water hammering occurs, damage to the piping system may result.

A number of different steam traps are available including mechanical traps, thermostatic traps and thermodynamic traps. The thermodynamic trap is widely used in steam systems as they provide a robust steam trap with a simple mode of operation. The thermodynamic steam trap operates by means of the dynamic effect of flash steam as it passes through the trap. The only moving part in the steam trap is a disc positioned above a flat face inside a control chamber or cap. On start-up, upstream pressure raises the disc, and cool condensate plus air is discharged from under the disc, and out through peripheral outlets. Hot condensate flowing through the inlet passage into the chamber under the disc drops in pressure and releases flash steam moving at high velocity. This high velocity creates a low-pressure area under the disc, drawing it towards its seat. Simultaneously, the flash steam pressure builds up inside the chamber above the disc, forcing it down against the incoming condensate until it seats on the inner and outer rings. At this point, the flash steam is trapped in the upper chamber, and the pressure above the disc equals the pressure being applied to the underside of the disc from the inner ring. However, the top of the disc is subject to a greater force than the underside, as it has a greater surface area. Eventually the trapped pressure in the upper chamber falls as the flash steam condenses. The now higher condensate pressure raises the disc and the cycle repeats.

Steam traps are typically arranged to provide a maximum level of condensate discharge based on the diameter of the piping and size of the trap. The level of condensate is generally minimized and controlled by the insulation placed around the steam pipe system. Typically, the stream traps are installed in pairs that are arranged in parallel as shown in FIG. 1. The parallel arrangement allows for redundancy in the event one steam trap becomes blocked or its capacity is reduced. In a common arrangement, the main steam pipe 22 is connected directly in line with a first steam trap 14. A fitting, such as a t-fitting 16 for example, upstream from the first steam trap, connects the second steam trap 15. Each of the steam traps 14, 15 is then connected to a common outlet conduit 17 which couple the steam traps 14, 15 to a test valve 18. The test valve 18 allows personnel to directly observe the discharge of the condensate. Due to the orientation of the first steam trap 14 with the main steam pipe 22, it has been found that a large amount of the debris in the steam enters the first steam trap 14. It has further been found that approximately 80% of blocked steam traps found in the field are positioned in the upper run.

Unfortunately, in some circumstances the levels of condensate can increase, such as when surrounding storm water drains and sewers are not maintained. For example, if the surrounding storm water drain has a crack, rainwater may flow around the conduit housing steam pipes. If the conduit is compromised, the water may then flow around the steam pipe cooling the steam pipe and causing excess water to condense. Additional problems may occur if the steam trap is compromise by debris causing the steam trap to remain partially closed or become blocked. When the level of condensate generation exceeds the capacity of the steam trap, the condensate may eventually back up into the main steam pipe system.

Accordingly, while existing steam trap arrangements are suitable for their intended purpose, there still remains a need for improvements particularly regarding the arrangement of steam trap systems to reduce the amount of debris transported to the steam trap, in detecting blocked steam traps, and improving the discharge capacity.

### BRIEF DESCRIPTION OF THE INVENTION

According to one aspect of the invention, a steam trap is provided. The steam trap includes an inlet header having an inner bore and a first inlet port and a first and second outlet port fluidly coupled to the inner bore. A strainer is positioned within the inner bore adjacent the first and second outlet port. An outlet header is provided having a second inlet port fluidly coupled to the first outlet port and a third inlet port fluidly coupled to the second outlet port. A first steam trap coupled between the first outlet port and the second inlet port. A second steam trap is coupled between the second outlet port and the third inlet port.

According to another aspect of the invention, another steam trap is provided. The steam trap includes an inlet header having an inner bore, the inlet header having a plurality of outlets. A strainer is arranged within the inner bore adjacent to the plurality out outlets. A plurality of conduits, each of the plurality on conduits being fluidly coupled to one of the plurality of outlets. An outlet header having a plurality of inlets, wherein each of the plurality of inlets is fluidly coupled to one of the plurality of conduits. A plurality of steam traps, wherein each of the steam traps is fluidly coupled to one of the plurality of conduits between each of the plurality of inlets and the plurality of outlets. A first plurality of sensors, each of the plurality of sensors being operably coupled to one of the plurality of conduits between the plurality of steam traps and the plurality of outlets. A second plurality of sensors, each of the plurality of sensors being operably coupled to one of the plurality of conduits between the plurality of steam traps and the plurality of inlets.

According to yet another aspect of the invention, a method of detecting a blocked steam trap is provided. The method includes the step of measuring a first parameter upstream of a stream trap. A second parameter is measured downstream of the stream trap. An ambient parameter is measured. The first parameter, the second parameter and the ambient parameter are compared. It is determined that the steam trap is blocked if the first parameter is substantially equal to the ambient parameter.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a front plan view illustration of a prior art steam trap arrangement;

FIG. 2 is a front plan view illustration of a steam trap arrangement in accordance with an exemplary embodiment of the invention;

FIG. 3 is a side plan view illustration of the steam trap arrangement of FIG. 1;

FIG. 4 is a front sectional view of an exemplary inlet header used in the steam trap arrangement of FIG. 1;

FIG. 5 is side sectional view of the exemplary inlet header used in the steam trap arrangement of FIG. 1;

FIG. 6 is a partial top sectional view of the exemplary inlet header used in the steam trap arrangement of FIG. 1;

FIG. 7 is a partial side plan view of an exemplary strainer used in the steam trap arrangement of FIG. 1;

FIG. 8 is a block diagram of a method of operation of the steam trap arrangement of FIG. 1;

FIG. 9 is a partial front plan view of another embodiment of a junction having a three sensor arrangement;

FIG. 10 is a partial front plan view of another embodiment of a junction having another three sensor arrangement; and,

FIG. 11 is a partial front plan view of another embodiment of a steam trap having an upstream and downstream sensor arrangement.

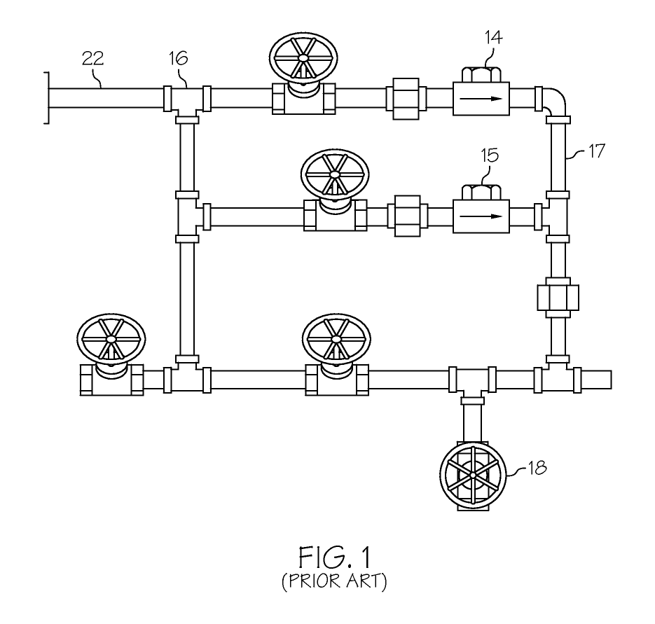

The detailed description explains embodiments of the invention, together with advantages and features, by way of example with reference to the drawings.

### DETAILED DESCRIPTION OF THE INVENTION

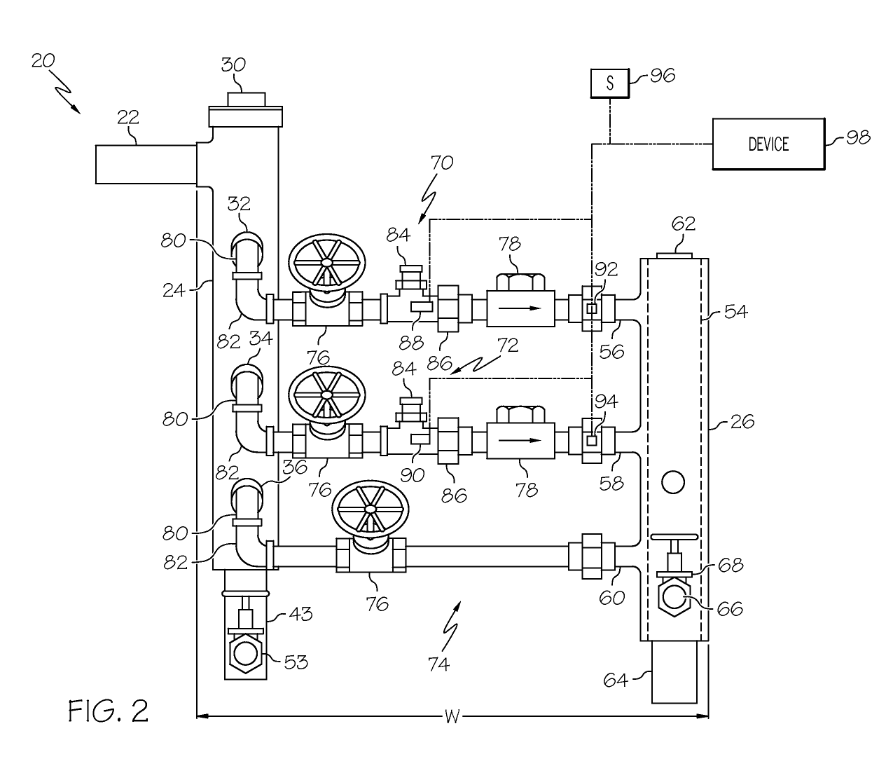

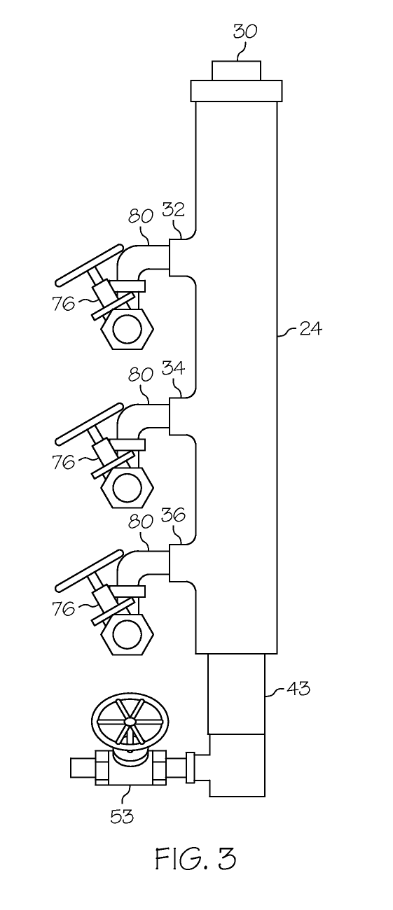

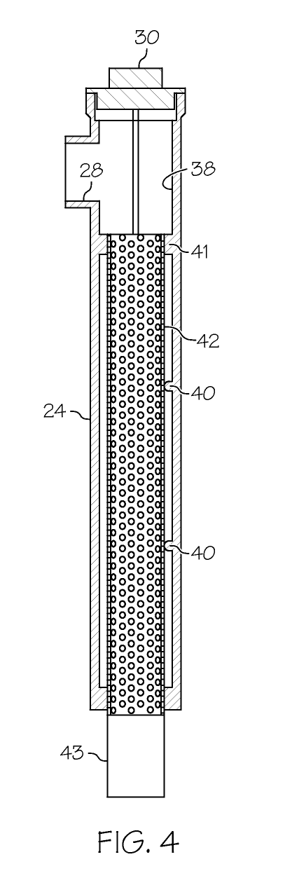

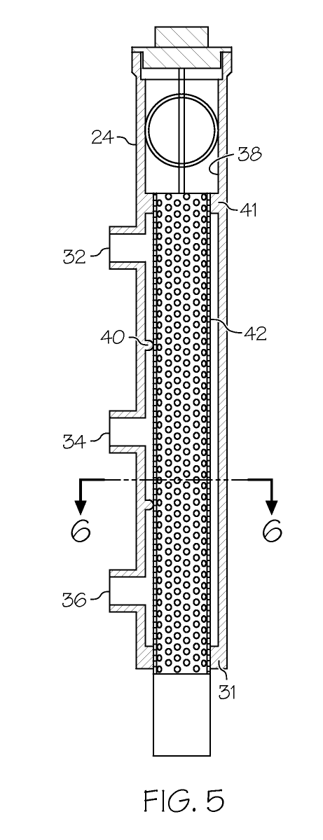

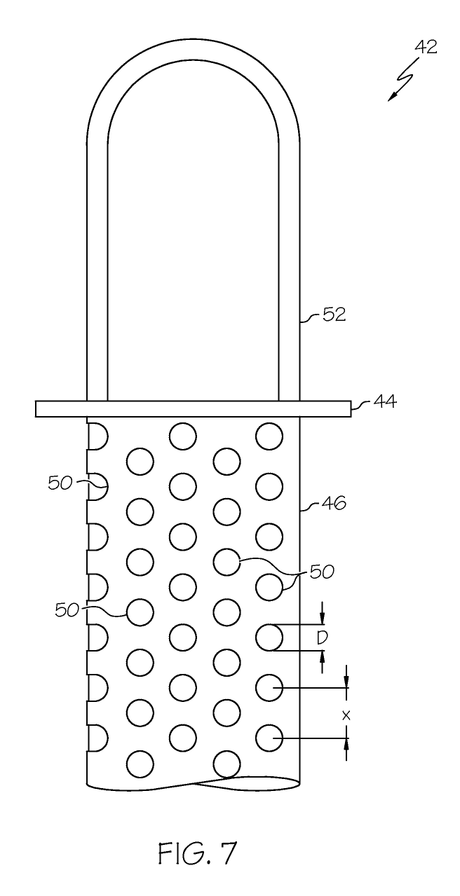

Steam traps are used in a variety of applications to drain liquid condensate from a steam system. An exemplary steam trap arrangement 20 is illustrated in FIGS. 2-7. In this embodiment, an inlet pipe 22 is connected to a system for transporting steam (not shown), such as a district heating system for example. The steam trap arrangement 20 is typically located at one or more points in the steam system to allow the migration of condensate under the influence of pressure and gravity. The steam trap arrangement 20 may be located at low points, in areas where there is long run of pitched pipe, or upstream from a valve in a pitched pipe for example. It should be appreciated that a steam system may have multiple steam trap arrangements 20.

The steam trap arrangement 20 includes an inlet header 24 and an outlet header 26. The inlet header 24 is fluidly coupled to the inlet pipe 22 to receive condensate through an inlet port 28. In the exemplary embodiment, the inlet header 24 is substantially vertical to allow the flow of condensate under gravity. Coupled to one end of the inlet header 24 is a cap 30 adjacent the inlet port 28. The cap 30 is removable by service personnel to allow maintenance of the steam trap arrangement 20. The inlet header 24 further includes a plurality of outlet ports 32, 34, 36. The outlet ports are fluidly coupled to the inlet port 28 by an inner bore 38. As will be discussed in more detail below, the outlet ports 32, 34, 36 substantially perpendicular to the inlet port 28.

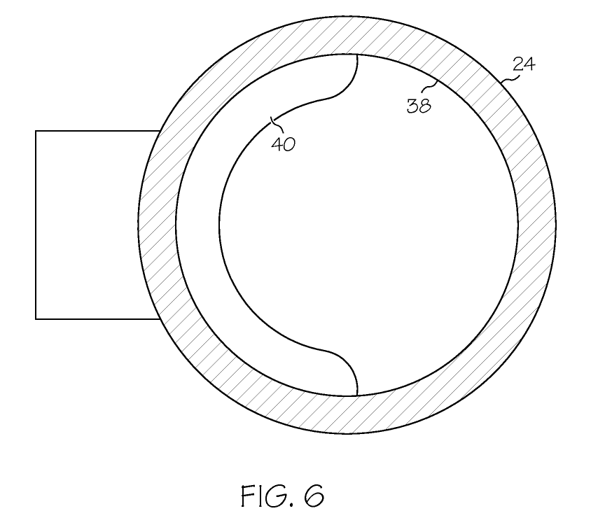

The inner bore 38 extends the length of the inlet header 24 from the cap 30 to a collar 31 on the opposite end. The inner bore 38 may include one or more ribs 40. The ribs 40 are arranged adjacent to and between the outlet ports 32, 34, 36. In the exemplary embodiment, the ribs 40 are semicircular (FIG. 6), extending halfway around the inner bore 38. Another rib 41 is positioned between the inlet port 28 and the first outlet port 32. The rib 41 extends around the circumference of the inner bore 38. It should be appreciated that while the ribs 40, 41 are each shown as a solid continuous projection from the wall of the inner bore 38, the ribs 40, 41 may be comprised standoffs or segments with gaps in between each of the segments.

As will be discussed in more detail below, the ribs 40, 41 define a gap between a strainer 42 and the outlet ports 32, 34, 36, to prevent the strainer 42 from restricting the flow of condensate into the outlet ports. Opposite to the cap 30, a nipple 43 is coupled to the inlet header 24. In one embodiment, the nipple 43 is secured to the collar 31 by a screw thread. In the exemplary embodiment, the inlet header 24 and cap 38 are made from bronze such as that defined by American Society for Testing and Materials (ASTM) B61 and the nipple 43 is made from brass. In one embodiment, the inlet header has a 3.5-inch (8.9 cm) diameter and is two feet (0.61 meters) long. In another embodiment, the inlet header 24 also conforms to American Society of Mechanical Engineers (ASME) Specification B31.1 with an operating pressure of 200 pounds per square inch (1379 kPa) and 413 degrees Fahrenheit (211° C.). In yet another embodiment, the inlet header 24 is made by an investment casting process, which provides further advantages by eliminating fittings that may develop leaks over time.

A strainer 42 is arranged within the inner bore 38. The strainer 42 includes a flange 44 that contacts and rests on the rib 41. Extending from the end of the flange 44 is a handle 52. The handle 52 is generally “U” shaped and sized to fit within the inner bore 38 beneath the cap 30. In one embodiment, the cap 30 contacts and compresses the handle 52 when the cap 30 is installed to assist in holding the strainer 42 in position. The handle 52 provides a means for the service personnel to remove the strainer 42 from the inlet header 24 while performing maintenance. Extending from the flange 44 is a perforated body 46. The body 46 extends past the outlet ports 32, 34, 36 into the nipple 43. In one embodiment, the body 46 fits tightly within the inner bore of the nipple 43 to prevent backflow or flow of debris around the body 46. In the exemplary embodiment, a plate 48 (not shown) closes the end of body 46 opposite the flange 44. In another embodiment, the end of body 46 opposite the flange 44 is open. The perforated body 46 includes a plurality of openings 50. As shown in FIG. 6, each opening 50 has a diameter “D” and is spaced apart at a distance “x”. The openings 50 in adjoining rows are offset by half of the distance “x”. In the exemplary embodiment, the openings 50 have a diameter “D” of 5/64 inches (0.2 cm) and are separated by a distance “x” of 7/64 inches (0.28 cm). In another embodiment, the opening 50 has a diameter “D” of 1/16 inches (0.159 cm). This exemplary strainer provides 10 times the flow rate of a typical screen in a 1 inch (2.54 cm) strainer. It should be appreciated that while the openings 50 are shown as being uniform, and equally spaced, other patterns or openings 50 of varying sizes may also be used. In one embodiment, that strainer 42 is made from stainless steel, such as that defined by ASTM specification A480 type 304 for example. The strainer 42 may also be made from other suitable materials such as, but not limited to, brass or copper.

The outlet header 26 includes an inner bore 54 having a plurality of inlet ports 56, 58, 60. A cap or bushing 62 encloses one end of the inner bore 54 adjacent the inlet port 56. A discharge conduit 64 is coupled to the outlet header 26 to close the end of the inner bore 54 opposite the bushing 62. A test port 66 is arranged on one end of the outlet header 26 between the inlet port 60 and the discharge conduit 64. In the exemplary embodiment, the outlet header 26 is made of bronze. A valve 68, such as a bronze gate valve for example, is fluidly coupled to the test port 66. It should be appreciated that the test port 66 and valve 68 may be positioned anywhere along the outlet header below the conduit 72. In one embodiment, the outlet header 24 conforms to ASME Specification B31.1 with an operating pressure of 200 pounds per square inch (1379 kPa) and 413 degrees Fahrenheit (211° C.). In another embodiment, the outlet header 26 is made by an investment casting process, which provides further advantages by eliminating fittings that may develop leaks over time.

The inlet header 24 and the outlet header 26 are fluidly coupled to each other by a plurality of conduits 70, 72, 74 that are associated with outlet ports 32, 34, 36 and inlet ports 56, 58, 60 respectively. In one embodiment, the length of the conduits 70, 72, 74 is such that the width “W” of the steam trap arrangement 20 is sized to fit through a manhole opening. The first conduit 70 and second conduit 72 include a valve 76, such as a bronze gate valve for example, and a steam trap 78 fluidly coupled in series. The conduits 70, 72 also include a first elbow 80 and a second elbow 82 fluidly arranged in series to offset the position of the valve 76 and steam trap 78 relative to outlet ports 32 and 34. The third conduit 74 is arranged similar to the conduits 70, 72 having a valve 76 and a first elbow 80 and second elbow 82. In another embodiment the first elbow 80 and a second elbow 82 may be arranged in series to offset the position of the steam trap 78 relative to the inlet ports 56 and 58. In the exemplary embodiment, the third conduit 74 does not include a steam trap. This allows service personnel to use the third conduit 74 as a bypass conduit. In the exemplary embodiment, the valve 76 is rotated on an angle relative to the longitudinal axis of the inlet header 24. The rotation of the valve 76 provides advantages in allowing service personnel access to the valve 76 to open or close the valve 76 from the street level using a tool without interference from adjoining conduits.

It should be appreciated that the steam trap arrangement 20 may include more conduits in parallel with the conduits 70, 72, 74 to allow increased capacity to discharge condensate. Further, where space permits, one advantage of the steam trap arrangement 20 is that the capacity of the steam trap arrangement 20 may be increased by coupling additional steam trap arrangements 20 in parallel. Further, the conduits 70, 72, 74 may include additional components, such as a junction 84 with a bushing 86 between the valve 76 and the steam trap 78 for example. Capacity could be further increased by utilizing higher capacity steam traps for trap 78.

In the exemplary embodiment, the brass components used in the steam trap arrangement 20 conform to ASTM B43-061 (Annealed) extra strong wall. The ends of the brass components are also square and prepared for brazing. Further, in one embodiment, the fabrication and brazing of components in the steam trap arrangement 20 conform to ASME B31.1.

Steam trap arrangement 20 also includes sensors, such as upstream temperature sensors 88, 90 and downstream sensors 92, 94 that are associated with the first 70 and second 72 conduits respectively. An optional ambient sensor, such as temperature sensor 96 for example, determines the temperature of the ambient air inside of the manhole. The temperature sensors may be any sensor suitable for reliably measuring temperatures in the environment the steam trap assembly 20 is located. Temperature sensors include, but are not limited to thermometers, resistance temperature detectors, thermocouples, thermistors, and pyrometers for example. The sensors 88, 90, 92, 94, 96 are connected to a device 98 that allows signals from the sensors 88, 90, 92, 94, 96 to be transmitted to a central controller (not shown) for additional analysis for monitoring and supervising the system 20. In another embodiment, the measurements sensors 88, 90, 92, 94, 96 may be stored in device 98 and analyzed by operators during maintenance or inspection procedures. As will be discussed in more detail below, the sensors 88, 90, 92, 94, 96 are arranged to assist in detecting a blockage of a steam trap, such as steam trap 78. In the exemplary embodiment, the sensors 88, 90, 92, 94 are mounted internally to the conduits 70, 72 and can be positioned anywhere along the conduit upstream and downstream of the steam trap.

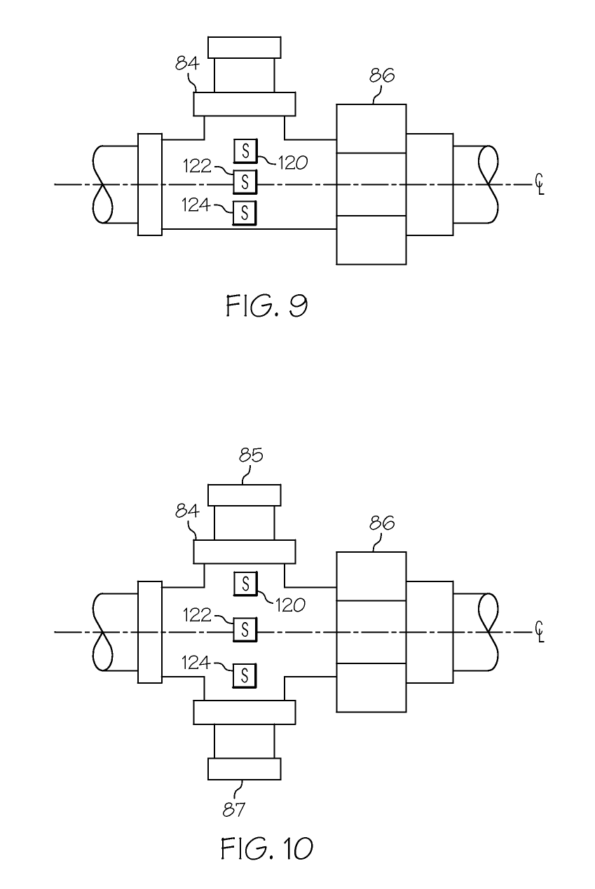

In another embodiment, three sensors 120, 122, 124 as shown in FIG. 9 and FIG. 10, may replace the sensor 88. In the embodiment of FIG. 9, the sensors 120, 122, 124 are arranged in parallel within the junction 84 with the first sensor 120 positioned near the top (when viewed in the vertical or upright position) of the inner diameter of junction 84 adjacent the bushing 86. The second sensor 122 is positioned substantially along the centerline of the junction 84, while the third sensor 124 is positioned along the bottom of the inner diameter of junction 84.

The embodiment of FIG. 10 uses a junction 84 having an upper fitting 85 and a lower fitting 87 to form an intersection. This allows the sensors 120, 122, 124 to be spaced farther apart such that the first sensor is arranged adjacent or within the upper fitting and the third sensor is positioned adjacent or within the lower fitting. Further, it should be appreciated that while the sensors 120, 122, 124 are illustrated as discrete or individual sensors, these sensors may also be integrated into a single device.

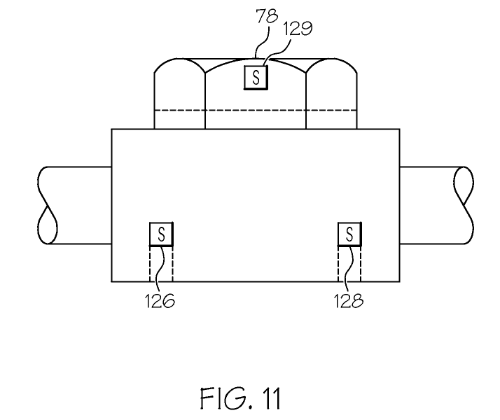

Another sensor arrangement for steam trap 78 is illustrated in FIG. 11. In this embodiment, pair of sensors 126, 128 are positioned inside the steam trap in the upstream and downstream halves of the steam trap through the body of the steam trap 78 respectively. Another sensor 129, is positioned within the cavity of the cap of the steam trap above the disk. It should be appreciated that the arrangement of sensors described herein can be grouped together in different combinations to determine the temperature of the trap. Also, the positioning and number of sensors described herein is exemplary and the claimed invention should not be so limited.

During operation, the steam trap arrangement 20 receives condensate from the inlet pipe 22. The condensate falls into the inlet header 24 under the influence of gravity and into the strainer 42. It should be appreciated that debris entrained in the condensate will tend to collect in the bottom of the inlet header 24. This debris may be periodically discharged through a lower discharge valve 53 during periodic inspections. As the level of condensate in the inner bore 38 raises, the condensate will flow into the conduit 72 and eventually into conduit 70 if the rate of condensate generation is sufficiently high. It should be appreciated that any debris suspended in the condensate that is bigger than the opening 50 will not flow into the conduits 70, 72. Further, since the elbows 80, 82 are arranged to position a substantial portion of the conduits 70, 72 vertically below the outlet ports 32, 34, the condensate will not flow back out of the conduits 70, 72 and into the inlet header 24. If the steam traps 78 are functioning properly, the condensate flows through the steam trap 78, into the outlet header 26 and through the discharge conduit 64.

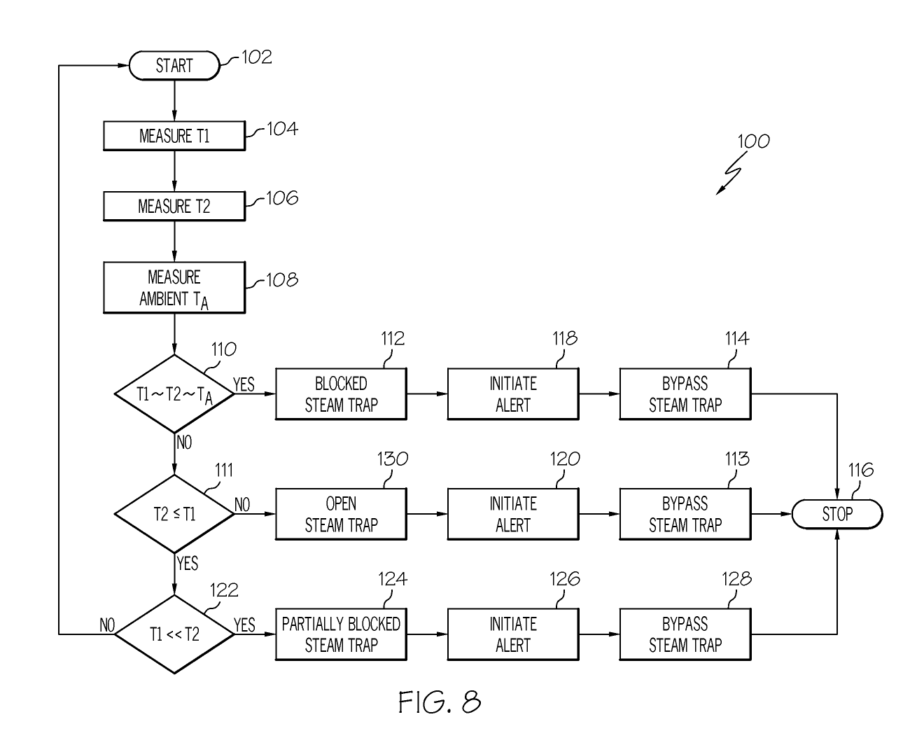

Referring now to FIG. 8, a method 100 of determining if a steam trap, such as steam trap 78 for example, is shown). The method 100 starts in block 102 and proceeds to block 104 where a temperature upstream from a steam trap is measured, such as with temperature sensor 90 for example. The method 100 then proceeds to block 106 where a temperature downstream from a steam trap is measured, such as with sensor 92 for example. The method 100 then proceeds to measure an ambient temperature in block 108. As discussed above, due to the positioning of the conduits, such as conduit 70 for example, relative to the outlet ports in the inlet header, such as outlet port 32 for example, the condensate cannot substantially flow out of the conduit except through the steam trap 78. If the steam trap is operating normally, the temperature measured by the upstream temperature sensors 88, 90 remain at the steam saturation temperature. However, if the steam trap 78 becomes blocked, the condensate will sit in the conduit and decrease substantially in temperature. In one embodiment, the temperature sensor 88 measures a temperature drop to substantially the saturation temperature of steam at the outlet header 26. Where the outlet header 26 is at ambient pressure, the saturation temperature will 212° F. (100° C.). It should be appreciated that in some applications, the discharge conduit 64 may be coupled to an extensive drainage system that results in a backpressure being applied to the outlet header 26. Therefore, the actual temperature measured by sensor 88 will depend on the amount of backpressure (if any) in the outlet header 26. The temperature drop at sensor 90 will be equal to or greater than that measured by sensor 88.

Another failure mode for steam traps is for the trap to remain stuck in the open position. When this occurs, steam escapes through the steam trap and into the outlet header. Thus, when the trap remains in the open position, the downstream temperature sensors 92, 94 remain at the elevated steam saturation temperature and do not periodically decrease to ambient steam saturation temperature.

After measuring the ambient temperatures in block 108, the method 100 proceeds to query block 110 where the upstream temperature T1 and the ambient temperature T_{A} are compared. If the temperatures are approximately equal, e.g. T1˜T_{A}, then query block 110 returns a positive and the method 100 proceeds to block 112 where a blocked steam trap is indicated. The method 100 then proceeds to block 118 where an alarm is initiated and to optional block 114 where the blocked steam trap is bypassed and maintenance is performed. The method 100 then terminates in block 116.

If the temperatures are not approximately equal, e.g. T1 is greater than T_{A} then the query block 110 returns a negative and the method 100 proceeds to query block 111 where the downstream temperatures T2 are compared to ambient temperature T_{A}. If the temperature T2 remains approximately equal to or slightly greater than TA, the query block 111 returns a positive and the method 100 loops back to start block 102. If the temperature T2 remains equal to T1, then query block 111 returns negative, and proceeds to block 130 indicating that the steam trap is stuck open. The method 100 proceeds to block 120 where an alarm is initiated and to optional block 113 where the valve 76 is closed and the trap is maintained to prevent steam from being continuously discharged.

If the temperatures are approximately equal, the method 100 proceeds to query block 122 where it is determined if T2 is greatly less than T1. If the difference between T2 and T1 is large, this may indicate a partially blocked trap. If query block 122 returns a negative (e.g. no partial block), the method 100 loops back to start block 102. If query block 122 returns a positive, the method 100 proceeds to block 124 where it is determined that a trap is partially blocked. An alarm is initiated in block 126 and to optional block 128 where the trap 78 is maintained. The method 100 then terminates in block 116.

It should be appreciated that the method 100 may be performed by device 98 for example, or the measurement data may be transmitted to a remotely located facility that monitors the operation of the steam system. The device 98 may be a microprocessor, microcomputer, a minicomputer, a board computer, a complex instruction set computer, an ASIC (application specific integrated circuit), a reduced instruction set computer, a computer network, an analog circuit, or a hybrid of any of the foregoing. The device 98 may also be the system described in co-pending patent application entitled “Remote Monitoring System”, Ser. No. 61/151,289, which is incorporated herein by reference. The device 98 may also have one or more circuits or devices for communicating, both transmitting and receiving signals, with the remotely located facility. In another embodiment, the device 98 includes a graphical device, such as an LED or a liquid crystal display for example, that displays the measured temperatures allowing service personnel performing inspections to determine whether there is a potential for a blocked steam trap.

It should also be appreciated that while the exemplary embodiments provided herein refer to temperature measurements, this is for exemplary purposes and the claimed invention should not be so limited. The measurement of other physical parameters may also be used. In one embodiment, pressure sensors, such as a pressure transducer for example, are used instead of temperature sensors. Since changes in pressure within the steam trap 20 will directly correlate with the changes in temperature, the measurement of pressure may be used instead of temperature measurements. In other embodiments, the steam trap 20 may use a combination of temperature and pressure to determine the operating state and condition of the steam trap 20.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A steam trap comprising:
an inlet header having an inner bore and a first inlet port and a first and second outlet port fluidly coupled to said inner bore;
a strainer positioned within said inner bore adjacent said first and second outlet port;
an outlet header having a second inlet port fluidly coupled to said first outlet port and a third inlet port fluidly coupled to said second outlet port;
a first steam trap coupled between said first outlet port and said second inlet port;
a second steam trap coupled between said second outlet port and said third inlet port.

2. The steam trap of claim 1 further comprising:
a first valve fluidly coupled between said first steam trap and said first outlet; and,
a second valve fluidly coupled between said second steam trap and said second outlet.

3. The steam trap of claim 1 wherein said strainer includes a plurality of openings.

4. The steam trap of claim 3 wherein said openings are 5/64 inch diameter openings arranged 7/64 inch apart.

5. The steam trap of claim 1 wherein said inner bore includes a first rib positioned between said first inlet and said first outlet.

6. The steam trap of claim 5 wherein said strainer includes a flange on one end, wherein said flange is adjacent said first rib.

7. The steam trap of claim 6 wherein said inner bore includes a second rib portioned between said first outlet and said second outlet.

8. The steam trap of claim 1 further comprising:
a first sensor operably coupled between said first outlet and said first stream trap; and,
a second sensor operably coupled between said first steam trap and said second inlet.

9. A steam trap comprising:
an inlet header having an inner bore, said inlet header having a plurality of outlets;
a strainer arranged within said inner bore adjacent to said plurality out outlets;
a plurality of conduits, each of said plurality on conduits being fluidly coupled to one of said plurality of outlets;
an outlet header having a plurality of inlets, wherein each of said plurality of inlets is fluidly coupled to one of said plurality of conduits;
a plurality of steam traps, wherein each of said steam traps is fluidly coupled to one of said plurality of conduits between each of said plurality of inlets and said plurality of outlets;
a first plurality of sensors, each of said plurality of sensors being operably coupled to one of said plurality of conduits between said plurality of steam traps and said plurality of outlets; and,
a second plurality of sensors, each of said plurality of sensors being operably coupled to one of said plurality of conduits between said plurality of steam traps and said plurality of inlets.

10. The steam trap of claim 9 wherein said inlet header includes a plurality of ribs positioned in said inner bore adjacent said plurality of outlets.

11. The steam trap of claim 10 wherein said plurality of ribs define a gap between said strainer and said plurality of outlet ports.

12. The steam trap of claim 11 wherein said plurality of ribs are semi-circular.

13. The steam trap of claim 12 further comprising a bypass conduit extending between a bypass outlet in said inlet header and a bypass inlet in said outlet header.

14. The steam trap of claim 13 further comprising a plurality of valves, wherein each of said plurality of valves is fluidly coupled to one of said plurality of conduits between said plurality of steam traps and said plurality of outlets, wherein said plurality of valves is arranged on an angle relative to said inlet header and said outlet header.

15. The steam trap of claim 9 wherein said first plurality of sensors and said second plurality of sensors are temperature sensors.

16. The steam trap of claim 9 wherein said first plurality of sensors and said second plurality of sensors are pressure sensors.

17. A method of detecting a blocked steam trap comprising:
measuring a first parameter upstream of a stream trap;
measuring a second parameter downstream of said stream trap;
measuring an ambient parameter;
comparing said first parameter, said second parameter and said ambient parameter;
determining said steam trap is blocked when said first parameter is substantially equal to said ambient parameter.

18. The method of claim 17 wherein said first parameter is a first temperature, said second parameter is a second temperature, and said ambient parameter is an ambient temperature.

19. The method of claim 18 further comprising determining said steam trap is blocked if said first temperature and said second temperature are substantially equal to said ambient temperature.

20. The method of claim 19 further comprising:
measuring said first temperature over time; and,
determining said stream trap is blocked if said first temperature trends towards said ambient temperature.

21. The method of claim 17 wherein said first parameter is a first pressure, said second parameter is a second pressure, and said ambient parameter is an atmospheric pressure.
